(19) United States
(12) Patent Application Publication
(10) Pub. No.: US 2011/0268126 A1
(43) Pub. Date: Nov. 3, 2011

(54) INFORMATION COMMUNICATION SYSTEM, NODE DEVICE, INFORMATION COMMUNICATION METHOD AND COMPUTER READABLE STORAGE MEDIUM

(75) Inventor: HIDEKI MATSUO, NAGOYA-SHI (JP)

(73) Assignee: BROTHER KOGYO KABUSHIKI KAISHA, NAGOYA-SHI (JP)

(21) Appl. No.: 13/094,427

(22) Filed: Apr. 26, 2011

(30) Foreign Application Priority Data
Apr. 28, 2010 (JP) 2010103791

(51) Int. Cl. H04L 12/56

(52) U.S. Cl. 370/400

(57) ABSTRACT

A node device of an information communication system using an overlay network formed by a plurality of the node devices connected via a network, the node device comprises a reception unit configured to receive a control message for controlling the information communication system or content data transmitted and received among the plurality of node devices in the information communication system, a relay unit configured to relay the control message or the content data received by the reception unit to another one of the node devices, and a control unit configured to control the relay unit to relay the control message in preference to the content data.

### CROSS REFERENCE TO RELATED APPLICATION

This application claims priority from Japanese Patent Application No. 2010-103791 filed on Apr. 28, 2010, the entire contents of which are incorporated herein by reference.

### BACKGROUND OF THE INVENTION

1. Field of the Invention

The present invention relates to an overlay network system. Especially, the present invention relates to a peer-to-peer (P2P) communication system including a plurality of node devices communicable with one another through a network, specifically to a technique of increasing the operational efficiency of the peer-to-peer communication system.

2. Description of the Related Art

This type of peer-to-peer communication system is formed by a plurality of node devices. The content data of each of a variety of content items is distributively stored in a plurality of node devices as a plurality of replicated data items of the content data. The replicated data will be hereinafter referred to as the “replica”. The content data refers to the content data of a movie, a music piece, or the like. An information communication system is commonly known which allows the use of the replica among the node devices. With this system, the fault tolerance and the access distribution are improved. The location of the thus distributively stored replica can be efficiently retrieved by the use of a distributed hash table (hereinafter referred to as the DHT (Distributed Hash Table)). In the above-described peer-to-peer communication system, a variety of control messages different from the content data are transferred among the node devices to be transmitted and received by the node devices. Thereby, the system can operate as a peer-to-peer communication system.

In the past, a relay node device has been disclosed. The relay node device, when a control message is transferred via a relay device that requires to cross the NAT (Network Address Translation) boundary, relays the message. When the relay node device receives a control message from a node device incapable of crossing the NAT boundary, the relay node device replaces the IP (Internet Protocol) address of the transmission source of the message with the IP address of the relay node device. Further, when the relay node device receives a control message from a node device capable of crossing the NAT boundary and transfers the control message to a node device incapable of crossing the NAT boundary, the relay node device replaces the IP address of the relay node device with the IP address of the node device incapable of crossing the NAT boundary as the IP address of the transmission destination of the message.

### SUMMARY OF THE INVENTION

However, when given information is being transferred or relayed by a node device or a relay node device, standby or cancellation of the relay of other information occurs in some cases. For example, if content data larger in data size than the control message is being relayed, the relay node causes the standby or cancellation of the relay of the control message before the relay of the content data is completed. This is because the bandwidth of the relay node device is occupied with the relay of the content comprising the large data size. In a peer-to-peer communication system, the data size of the content data is generally larger than the data size of the control message. Therefore, the transfer or relay of the control message is delayed, or the control message is cancelled. Accordingly, the control message fails to be transferred or relayed to a location subsequent to the transfer destination of the relay node device. As a result, there arises an issue of a substantial reduction in operational efficiency of the peer-to-peer communication system.

Aspects of the invention provide an information communication system using an overlay network formed by a plurality of node devices connected via a network, at least one of the plurality of node devices comprises a reception unit configured to receive a control message for controlling the information communication system or content data transmitted and received among the plurality of node devices in the information communication system, a relay unit configured to relay the control message or the content data received by the reception unit to another one of the node devices, and a control unit configured to control the relay unit to relay the control message in preference to the content data.

Aspects of the invention provide a node device of an information communication system using an overlay network formed by a plurality of the node devices connected via a network, node device comprises a reception unit configured to receive a control message for controlling the information communication system or content data transmitted and received among the plurality of node devices in the information communication system, a relay unit configured to relay the control message or the content data received by the reception unit to another one of the node devices, and a control unit configured to control the relay unit to relay the control message in preference to the content data.

Aspects of the invention provide a non-transitory computer readable storage medium recording a program for operating a computer of a node device of an information communication system using an overlay network formed by a plurality of node devices connected via a network, the program causing the computer of the node device to execute receiving a control message for controlling the information communication system or content data transmitted and received among the plurality of node devices in the information communication system, relaying the control message or the content data received by the reception step to another one of the node devices, and controlling the relay step to relay the control message in preference to the content data.

Aspects of the invention provide an information communication method using an overlay network formed by a plurality of node devices connected via a network, the method comprises receiving a control message for controlling the information communication system or content data transmitted and received among the plurality of node devices in the information communication system, relaying the control message or the content data received by the reception step to another one of the node devices; and controlling the relay step to relay the control message in preference to the content data.

### BRIEF DESCRIPTION OF THE DRAWINGS

FIG. 1 is a diagram illustrating an example of connection form of node devices in an information communication system of an embodiment of the present invention;

FIG. 2 is an explanatory diagram illustrating an explanation of the relay of content data by relay nodes;

FIG. 3 is a block diagram illustrating an electrical configuration of a node device of the present embodiment;

FIG. 4 is a flowchart illustrating a process procedure of a main operation performed in the node device;

FIG. 5 is a flowchart illustrating a process procedure of a content data relay process performed in the node device; and

FIG. 6 is a flowchart illustrating a process procedure of a node determination process performed in the node device.

### DESCRIPTION OF THE PREFERRED EMBODIMENTS

### Preferred Embodiment

preferred embodiment of the present invention will be described below on the basis of the drawings. Described below is an embodiment of the present invention applied to a peer-to-peer information communication system.

### [Schematic Configuration of Information Communication System]

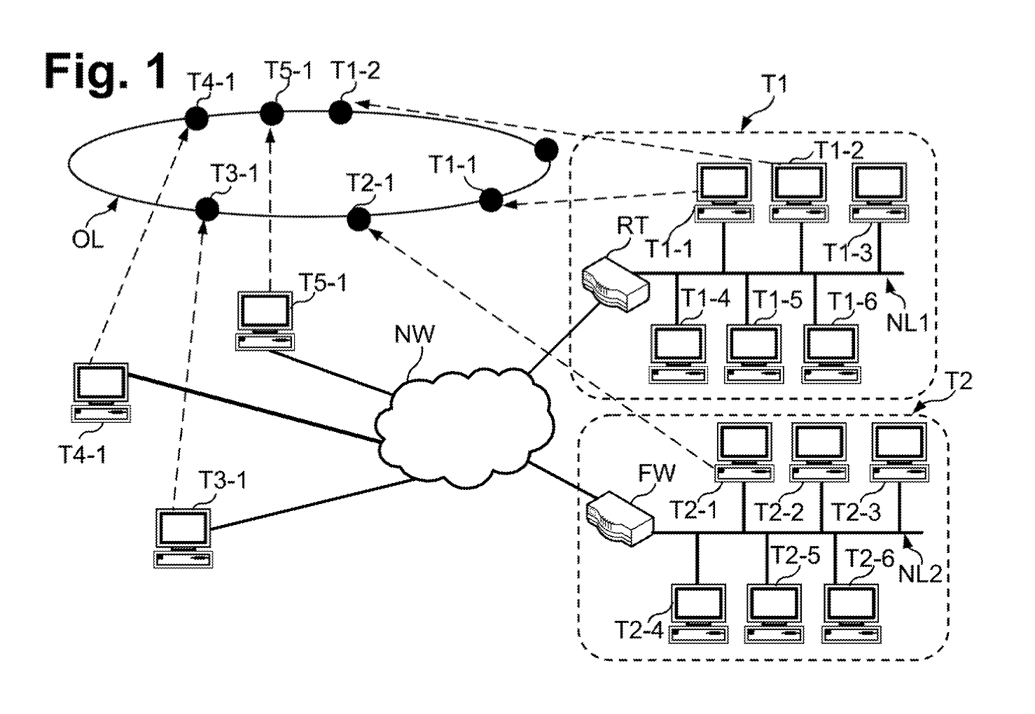

With reference to FIG. 1, description will be first made of a schematic configuration of an information communication system S of the present embodiment. As illustrated in FIG. 1, the information communication system S is formed by a plurality of node devices Tm-n (n represents one of numbers 1, 2, 3, The plurality of node devices Tm-n are communicable with one another via a network NW. The network NW is a communication network in the real world, e.g., the Internet.

The network NW is a network for interconnecting hub networks NLm (m represents one of numbers 1, 2, 3, . . . ). The network NW includes, for example, the Internet, a WAN (Wide Area Network), and so forth. Further, the network NW is constructed by, for example, an IX (Internet Exchange), an ISP (Internet Service Provider), the equipment of a DSL (Digital Subscriber Line) provider, the equipment of an FTTH (Fiber To The Home) line provider, communication lines, and so forth. The network NW may be a dedicated network for the information communication system S.

In the present embodiment, the network NW includes one or more hub networks NLm formed therein. Further, each hub network NLm is connected to a plurality of node devices Tm-n (n represents one of numbers 1, 2, 3, . . . ). Each hub network NLm is a network constructed in the site of the corresponding hub m. The hub includes, for example, a company, a school, a hospital, a tutoring school, and so forth. The hub network NLm is constructed by, for example, a LAN (Local Area Network) or the like. Alternatively, the hub network NLm may be a network constructed by a plurality of interconnected LANs. In this case, the plurality of LANs are connected via a network device, such as a router. The network constructed by a plurality of interconnected LANs includes, for example, a CAN (Campus Area Network) and so forth. Each hub network NLm is connected to a firewall FW or a broadband router BR. The firewall FW or the broadband router BR is a communication device which allows communication between a node device Tm-n connected in a hub and a node device Tm-n other than the node device Tm-n connected to the hub. The firewall FW or the broadband router BR is publicly known, and thus detailed description thereof will be omitted. Which one of the firewall FW and the broadband router BR may be installed to a hub is arbitrarily determined for each hub. The hub network NLm of the present embodiment is, for example, a LAN.

Further, the network NW is connected to a central server and an input server. The central server and the input server are not particularly illustrated in the drawing. The central server stores the original content data transmitted and received in an overlay network OL described later. Further, the central server transmits content catalog information to a node device Tm-n. Details of the content catalog information will be described later. The input server is a server device which inputs content data to the later-described overlay network OL. Herein, the input of content data refers to making content data acquirable from a node device Tm-n. The content data will be referred to as the “content”.

Each node device Tm-n is assigned with a manufacturer's serial number and an IP address unique thereto. Further, each node device Tm-n connected to the information communication system S is assigned with a node ID (Identifier), which is identification information unique thereto and represented by a number of predetermined digits. In the information communication system S of the present embodiment, the overlay network OL for content delivery is constructed. The overlay network OL is an overlay network constructed on the network NW. In other words, the overlay network OL is a logical network generated on a physical network. Further, the overlay network OL is realized by a specific algorithm, e.g., an algorithm using a distributed hash table. The distributed hash table will be hereinafter referred to as the “DHT (Distributed Hash Table)”. Such DHT routing is also known in U.S. Patent Application Publication No. 2007/0283043 A1, which is incorporated herein by reference and hence the detailed description thereof is omitted.

In the present embodiment, the broadband router BR or the firewall FW sets up port forwarding in some cases to allow the node devices Tm-n to communicate in a peer-to-peer manner. The broadband router BR, for example, may preferably be configured to automatically set up port forwarding by using the UPnP (Universal Plug and Play) function or the like. The node device Tm-n will be hereinafter simply referred to as the node device.

### [Method of Participating in Overlay Network OL]

Each node device stores a routing table using the DHT (Distributed Hash Table). The routing table specifies the transfer destination of each of a variety of control messages in the information communication system S. The control message is a message for controlling the operation of a P2P information communication system. In other words, the control message is a message used to retrieve or acquire content in a P2P information communication system. Further, the control message is a message transmitted and received in accordance with the DHT routing table. Specifically, the routing table registers therein a plurality of node information. The node information includes the node ID of a node device, and IP address and port number corresponding to the node device indicative of the node ID. The routing table registers a plurality of the node ID, which are separate from another node ID by an appropriate distance in an ID space.

A node device connected to the information communication system S stores, as the routing table, the node information of the minimum necessary number of node devices. With the control message transferred among the node devices, the node information of a node device, which has not been stored yet, is acquired. Further, with the control message transmitted and received by the node devices, the information communication system S can operate as a peer-to-peer information communication system.

The connection to the information communication system S is carried out when a node device not connected to the information communication system S transmits a participation message to an arbitrary node device connected to the information communication system S. The participation message is a message representing a request for participation in the information communication system S. The participation in the information communication system S refers to the connection of a node device to the information communication system S, which thereby allows the node device to acquire content data from the information communication system S. The arbitrary node device is, for example, a contact node constantly connected to the information communication system S. A node device intending to participate in the information communication system S transmits the participation message to the contact node. Thereby, the node device can acquire the DHT routing table from the contact node.

### [Overview of Content Acquisition Operation]

In the information ccmmunication system S, a variety of content data items comprising different contents are distributively stored in a plurality of node devices. Each content data item is assigned with a content name and a content ID. The content ID is identification information unique to each content data item. Attribute information, such as the content name and the content ID, of each content item is described in the content catalog information. The content catalog information is generated by the central server and distributed to all node devices. Further, each content item is divided into a plurality of data pieces. The divided data pieces are referred to as the “chunks”. The chunks are generated when the content item is divided into data pieces of a predetermined data size by the central server, for example. In the present embodiment, the minimum data size of the chunk is 2 MB (megabytes). Further, the maximum data size of the chunk is 128 MB. In some cases, however, some of the chunks have a data size less than 2 MB due to the division into the chunks. Further, there is a case in which the data size of the content item prior to the division into the chunks is less than 2 MB and thus the obtained chunks have a data size less than 2 MB. In the present embodiment, a content data item is divided into a plurality of chunks. However, a content data item may not be divided into a plurality of chunks, unlike the description of the present embodiment. undivided content data item may also be applied to the present embodiment.

The chunks are distributively stored in a plurality of node devices. Thereby, the original content is distributively stored in the plurality of node devices. The original of each of the chunks is stored in the central server. Each of the chunks is assigned with a sequence number and a chunk ID. The sequence number corresponds to, for example, the order of arrangement of the plurality of divided chunks arranged to form the original content. The chunk ID is identification information unique to each chunk.

Each node device that acquired the content ID of a given content item can acquire the chunk ID of each of the chunks forming the content item by associating the chunk ID with the corresponding sequence number. The chunk ID of each of the chunks forming the content item may be described in the content catalog information in association with the corresponding sequence number.

A node device storing the chunk is referred to as the “content holding node”. Further, the location of the chunk is stored, as index information, by a node device which manages or stores the location of the chunk. The node device managing the location of the chunk will be hereinafter referred to as the “root node”. The index information includes a group of the node information of the node device storing the chunk, the chunk ID of the chunk, and so forth. Such a root node is determined to be, for example, a node comprising a node ID closest to the chunk ID. The node ID closest to the chunk ID is, for example, a node ID larger than any other node IDs in the number of high-order digits matching the corresponding digits of the chunk ID.

If a user of a given node device wants to acquire desired content, the node device retrieves the content holding nodes storing the chunks forming the desired content. The node device desiring to acquire the chunks in accordance with the request from the user will be hereinafter referred to as the “user node”. Specifically, the user node transmits a retrieval message. The retrieval message includes the chunk ID of the chunk desired to be acquired and the node ID of the user node. The retrieval message is transmitted to another node device in accordance with the DHT routing table stored in the user node. That is, the user node transmits the retrieval message to the root node. Thereby, the retrieval message finally reaches the root node in'accordance with DHT routing using the chunk ID as a key. Such DHT routing is also known in U.S. Patent Application Publication No. 2007/0283043 A1, which is incorporated herein by reference and hence the detailed description thereof is omitted.

Upon receipt of the retrieval message, the root node acquires, from an index information cache, one or a plurality of index information items corresponding to the chunk ID included in the received retrieval message. The acquired index information is returned to the user node, which is the transmission source of the retrieval message. The user node that acquired the index information acquires or downloads the chunk on the basis of the index information. Specifically, on the basis of the IP address, the port number, and so forth of the content holding node included in the index information, the user node transmits a chunk request message to the content holding node. The chunk request message includes the node information of the user node, the content ID of the desired content, and the chunk ID of the chunk desired to be acquired. Upon receipt of the chunk request message, the content holding node transmits or uploads, to the user node, the chunk corresponding to the chunk ID included in the chunk request message. Meanwhile, if the content holding node storing the desired chunk is absent, the user node is unable to acquire the index information of the content holding node. In this case, the user node acquires the chunk from the central server.

Alternatively, the root node transmits a content transmission request message to the content holding node indicated by the IP address and so forth included in the index information. The content transmission request message includes the node information of the transmission source of the chunk request message. Upon receipt of the content transmission request message, the content holding node starts transmitting or uploading the corresponding content data to the user node indicated by the node information included in the received message. Thereby, the user node can acquire the content data from the content holding node.

Further, upon acquisition and storage of the chunk from the content holding node, the user node publishes the chunk. The publication of a chunk refers to the notification by the user node to the root node that the user node has stored the chunk as the content holding node. Due to the publication of the chunk, another node device can acquire the published chunk from the content holding node which has published the chunk. Specifically, the user node stored the chunk transmits a publish message. The publish message includes the chunk ID of the chunk and the node information of the user node stored the chunk. The publish message is transmitted to the root node. Thereby, the publish message reaches the root node in accordance with the DHT routing using the chunk ID as a key, in a similar manner as in the retrieval message. The root node stores, in the index information cache, the node information and the index information included in the received publish message. The index information included in, the publish message includes a group of chunk IDs. Thereby, the above-described user node newly serves as the content holding node storing the above-described chunk.

### [Control Message Relay Method by Relay Node Device]

An overview of the relay node device will be described below. In the present embodiment, a node device inside the broadband router BR or the firewall FW incapable of being connected from a node device outside the broadband router BR or the firewall FW will be referred to as the non-connectable node. Further, in the present embodiment, a node device capable of being connected from another node device will be referred to as the connectable node. The non-connectable node of the present embodiment is an example of a first node device of the present invention.

The node device that acquired the DHT routing table connects to another node device on the basis of the IP address and the port number described in the routing table. In this process, the node device that acquired the routing table establishes a session with the other node device. Specifically, the node device that established the session controls the transmission and reception of the control message to and from the other node, with which the session has been established. Further, once the session is established, the node device holds the session after the reception or transmission of the control message. The holding of the session is performed with session information registered in a socket table provided in a predetermined storage area of the node device. The session information includes, for example, the node information of the node device storing the socket table, the node information of the other node device connected to the node device, and a socket identifier. In this embodiment, the socket table is information comprising the IP address and the node ID associated with each other.

Further, the socket table is capable of registering therein a plurality of session information items. Accordingly, the sessions with a plurality of node devices can be held. However, the number of sockets is limited, e.g., approximately 60 to 120. If the number of the session information items registered in the socket table exceeds a predetermined number, therefore, the session information items are deleted, starting from the least used session information item. For example, the session information items are deleted from the socket table in accordance with the LRU (Last Recently Used) method. In this process, the session information of the session with the non-connectable node may continue to be registered, without being deleted as much as possible. In this case, the unused session information of the session with a node device other than the non-connectable node may be preferentially deleted from the socket table.

The IP address included in the node information of the non-connectable node corresponds to the network NW-side IP address of the broadband router BR or the firewall FW. That is, the network NW-side IP address is a global IP address. Further, the port number included in the node information of the non-connectable node is set to a port number of 0 (zero). This is because the IP address of the non-connectable node can be obtained by another node device, but the non-connectable node is incapable of crossing the broadband router BR or the firewall FW due to the port setting. Thus, the non-connectable node is unable to know the port number allowing the non-connectable node to cross the broadband r BR or the firewall FW. Therefore, the port number is set to 0. Further, a node device holding a session with the non-connectable node is configured to perform the processing of the relay node device for the non-connectable node.

Specifically, the relay node device sets a relay node table. Upon receipt of a message transmitted from the non-connectable node as the transmission source, the relay node device registers, in the relay node table, the node ID of the non-connectable node as the transmission source and the IP address and the port number of the non-connectable node corresponding to each other. For example, it is now assumed that a session has been established upon receipt of the start of the session from the non-connectable node. It is assumed herein that a control message transmitted from the non-connectable node as the transmission source and addressed to a node device other than the relay node device has been received. In this case, the relay node device registers, in the relay node table, the node ID of the non-connectable node and the IP address and the port number for connection to the non-connectable node.

Then, the relay node device rewrites the node information of the non-connectable node as the transmission source included in the control message into the node information of the relay node device. That is, the relay node device changes the node information of the transmission source included in the control message to the node information of the relay node. To make the rewriting of the node information traceable later, the relay node device adds the node ID assigned to the non-connectable node to the rewritten node information of the relay node, and then transmits the control message.

Further, upon receipt of a control message transmitted from a connectable node as the transmission source, the relay node determines whether or not the received control message is the control message to be transmitted to a non-connectable node holding a session with the relay node device. First, the relay node device determines whether or not the node ID representing the address of the received control message matches the node ID of the relay node device. If the relay node device determines the addresses do not match, the relay node device determines whether or not the node ID representing the address of the received control message is registered in the relay node table. If the node ID is registered in the relay node table, the relay node device determines the received message is the message addressed to the non-connectable node. Then, the relay node device relays the message to the non-connectable node registered in the relay node table. Meanwhile, if the node ID is not registered in the relay node table, the relay node device transfers the received control message to another node device on the basis of the DHT routing table.

In this process, if the relay node device determines the received control message is the control message transmitted to the non-connectable node as the address, the relay node device performs a control to transmit the received control message to the non-connectable node. If the relay node device determines that the address is registered in the relay node table, the relay node device changes the node information of the address of the received control message into the node information of the non-connectable node registered corresponding to the node ID included in the received message.

The node ID, the IP address, and the port number of the non-connectable node registered in the above-described manner are deleted from the relay node table, when the session with the non-connectable node is disconnected. The disconnection of a session means the deletion of the corresponding session information from a storage unit of the relay node device.

Description will be made of a method of determining whether each node device is the connectable node or the non-connectable node. In the present embodiment, when a node device participates in the information communication system S, the node device accesses a contact node. The contact node of the present embodiment is a node device accessed in the process of participating in the information communication system S. It is therefore assumed that the contact node is a connectable node assigned with a global IP address allowing communication in the network NW. Therefore, the node device transmitting the participation message can access the contact node, whether the node device is the connectable node device or the non-connectable node device. Meanwhile, there is a case in which the contact node is able to access the connectable node but unable to access the non-connectable node due to the broadband router BR or the firewall FW or due to the communication setting of a terminal device. The communication setting of a terminal device corresponds to the blocking of connection by a personal firewall or the like set in the terminal device. In the present embodiment, therefore, the contact node is requested to determine whether the node device is the connectable node or the non-connectable node. If the result of the determination by the contact node fails to be acquired within a predetermined period, it is assumed that the contact node is unable to access the non-connectable node due to the broadband router BR or the firewall FW or due to the communication setting of a terminal device. Therefore, the node device is determined as the non-connectable node. Meanwhile, if the result of determination by the contact node is received within the predetermined period; the node device is determined as the connectable node. The result of determination by the contact node that the node device is the connectable node or the non-connectable node is stored in a storage device of the node device as identification information indicating the connectable node or the non-connectable node. In the present embodiment, when a node device participates in the information communication system S, the participating node device transmits the participation message to the contact node. The participation message may be transmitted to a node device other than the contact node device to perform the participation process.

The above-described control message relay method by the relay node device is also known in U.S. Patent Application Publication No. 2008-294785 A1, which is incorporated herein by reference and hence the detailed description thereof is omitted.

### [Content Data Relay Method]

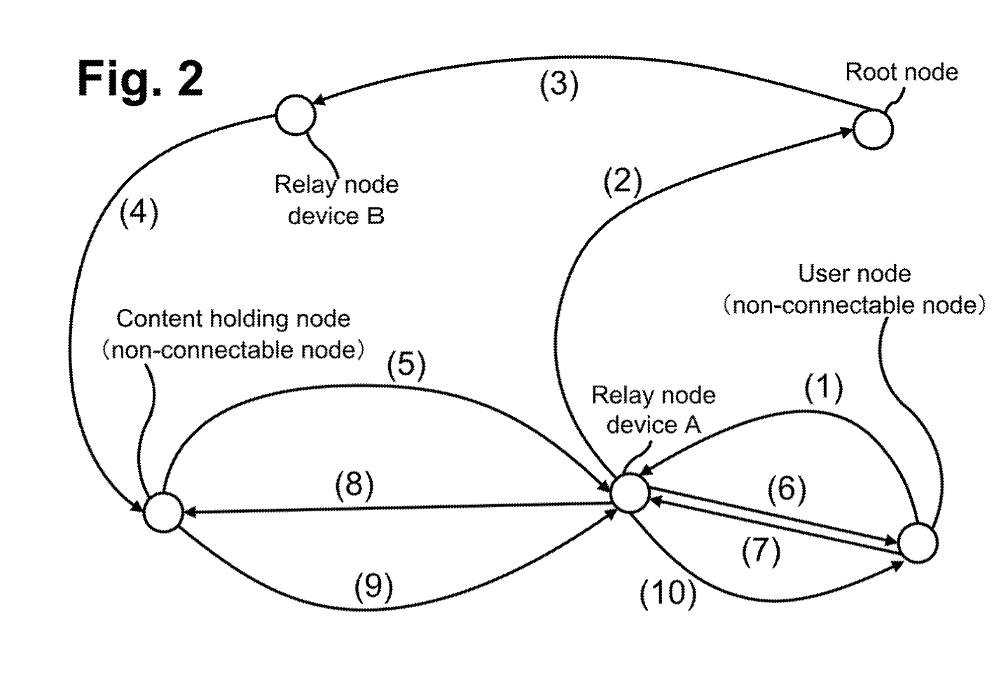

Subsequently, a method of relaying content data to the non-connectable node will be described with reference to FIG. 2. The relay of content data is performed when the user node and the content holding node are both non-connectable nodes. If the user node and the content holding node are both connectable nodes, a normal content acquisition operation is performed. Further, if the user node is the connectable node and the content holding node is the non-connectable node, the content holding node which is the non-connectable node, starts a session to the user node. The non-connectable node can acquire the IP address and the port number as the node information of the user node, which is the connectable node. Therefore, the content holding node as the non-connectable node can start a session to the user node as the connectable node. Further, if the user node is the non-connectable node and the content holding node is the connectable node, the user node, which is the non-connectable node, starts a session to the content holding node. The non-connectable node can acquire the IP address and the port number as the node information of the content holding node, which is the connectable node. Therefore, the user node as the non-connectable node can start a session to the content holding node as the connectable node.

If the user node is the non-connectable node, and if the content holding node is the non-connectable node, the non-connectable nodes are prevented from starting a session therebetween. In this case, the relay of content data by the relay node is performed.

The user node illustrated in FIG. 2 first transmits the retrieval message for retrieving a chunk ((1) in FIG. 2). In this case, the retrieval message includes the chunk ID of the chunk to be retrieved and the node information of the user node. On the basis of the chunk ID included in the message and the DHT routing table, the transmission destination of the retrieval message is determined. The user node illustrated in FIG. 2 is the non-connectable node. The retrieval message, therefore, also includes the identification information indicating that the transmission source of the retrieval message is the non-connectable node.

If the node device that received the retrieval message is the connectable node, it functions as the relay node device. Specifically, if the identification information included in the received retrieval message indicates the non-connectable node, and if the node device that received the message is the connectable node, the node device that received the message functions as the relay node device. In the example illustrated in FIG. 2, a relay node device A received the retrieval message rewrites the node information included in the retrieval message into the node information of the relay node device A, and then transmits the retrieval message to the root node ((2) in FIG. 2). Then, the received node ID of the non-connectable node and the node information of the non-connectable node are registered in association with each other in the relay node table of the relay node device A. On the basis of the index information stored in the root node, the root node received the retrieval message transmits the chunk request message to the content holding node corresponding to the chunk requested to be retrieved ((3) in FIG. 2). The node information of the relay node device A as the transmission source of the received retrieval message is set as the transmission source of the transmitted chunk request message.

The chunk request message transmitted by the root node is transferred to a relay node device B for the content holding node. In the example illustrated in FIG. 2, the content holding node is the non-connectable node. Therefore, the publish message of the content holding node is transmitted to the relay node device B. Then, the relay node device B that received the publish message rewrites the node information included in the publish message into the node information of the relay node device B. The rewritten publish message is transmitted to the root node by the relay node device B. Therefore, while the content holding node as the non-connectable node actually stores the chunk, the node information of the relay node device B for the content holding node is registered in the root node. For this reason, the chunk request message is transferred from the root node to the relay node device B. Then, on the basis of the relay node table stored in the relay node device B, the relay node device B received the chunk request message transfers the chunk request message to the content holding node holding a session with the relay node device B ((4) in FIG. 2).

Upon receipt of the chunk request message, the content holding node transmits a retrieval response message to the transmission source of the chunk request message. The retrieval response message is a message including the node information of the content holding node. In this case, the relay node device A is set as the transmission source of the chunk request message. Therefore, the retrieval response message is transmitted to the relay node device A ((5) in FIG. 2). When the retrieval response message is transmitted, a session is established between the content holding node and the relay node device A. After the establishment of the session, the retrieval response message is transmitted to the relay node device A.

In the basis of the relay node table stored in the relay node device A, the relay node device A that received the retrieval response message transfers the retrieval response message ((6) in FIG. 2).

Specifically, in accordance with the above-described determination method, the relay node device A determines whether the received retrieval response message is addressed to the relay node device A or to the non-connectable node. In the example of FIG. 2, the received retrieval response message is addressed to the non-connectable node. Therefore, the relay node table stored in the relay node device A is referred to. As a result of reference, the retrieval response message is transferred to the user node, which is the non-connectable node.

In the basis of the node information included in the retrieval response message, the user node received the retrieval response message transmits a chunk transmission request message. The chunk transmission request message is a message requesting the content holding node to transmit a chunk. In this case, the chunk transmission request message is transmitted to the relay node device A ((7) in FIG. 2). The relay node device A that received the chunk transmission request message transmits the chunk transmission request message to the content holding node through the session established upon receipt of the retrieval response message ((8) in FIG. 2). Then, the content holding node that received the chunk transmission request message transmits the requested chunk to the relay node device A ((9) in FIG. 2). Upon receipt of the transmitted chunk, the relay node device A transfers the received chunk to the user node ((10) in FIG. 2). With the relay node device relaying the content data or chunk in the above-described manner, it is possible to transmit and receive the content data or chunk, even if it is difficult to establish a session between the node devices. In this case, if the relay device relays both the content data or chunk and the control message, the communication load on the relay node device increases and causes a delay in the transmission and reception of the control message in some cases. To solve this issue, the present embodiment relays the control message in preference to the content data. In the following, description will be made of details of a preferential relay method of the present embodiment. The participation message, the retrieval message, the chunk request message, the publish message, the retrieval response message, the content transmission request message, and the chunk transmission request message of the present embodiment are examples of the control message. The control message of the present embodiment has a maximum size of a few KB (Kilo Bytes) or less. A control message has a minimum size of approximately 50 KB and a maximum size of approximately 500 KB. In some cases, the size of the control message may fall below 50 KB. If the data size of the relayed information is 500 KB or less, therefore, the information may be determined as the control message. Meanwhile, if the relayed information has a data size more than 500 KB, the information may be determined as the content data. Further, there is a case in which the content catalog information described in the present embodiment is distributively stored in a plurality of node devices. In this case, a message for retrieving the content catalog information may be also included in the control message. In the present embodiment, the minimum data size of the control message is 50 KB. Further, the maximum data size of the control message is 500 KB. In some cases, however, the data size of the control message may fall below 50 KB. A message other than transmitted and received content data may be included in the control message.

### [Method of Preferentially Relaying Control Message]

In the present embodiment, the relay node device periodically may determine the total data size of the information relayed thereby. Specifically, every time the relay node device relays information, the relay node device may add the data size of the relayed information to the total data size. Then, the relay node device periodically may reset the value of the total data size to zero. Thereafter, the relay node device may resume the addition of the data size of the information relayed thereby. In this process, when the total data size exceeds a predetermined value, the relay of new content data may be stopped. That is, newly relayed content data is cancelled. Further, even if the total data size exceeds the predetermined value, the relay of the control message may continue, without being cancelled. This is because the data size of the control message is smaller than the data size of the content data. The stopping or cancellation of the relay of the control message results in a reduction in operational efficiency of the information communication system S. For this reason, the control message comprising the small data size may continue to be relayed, even if the total data size exceeds the predetermined value. Consequently, it is possible to operate the information communication system S without reducing the operational efficiency thereof.

### [Electrical Configuration of Node Device]

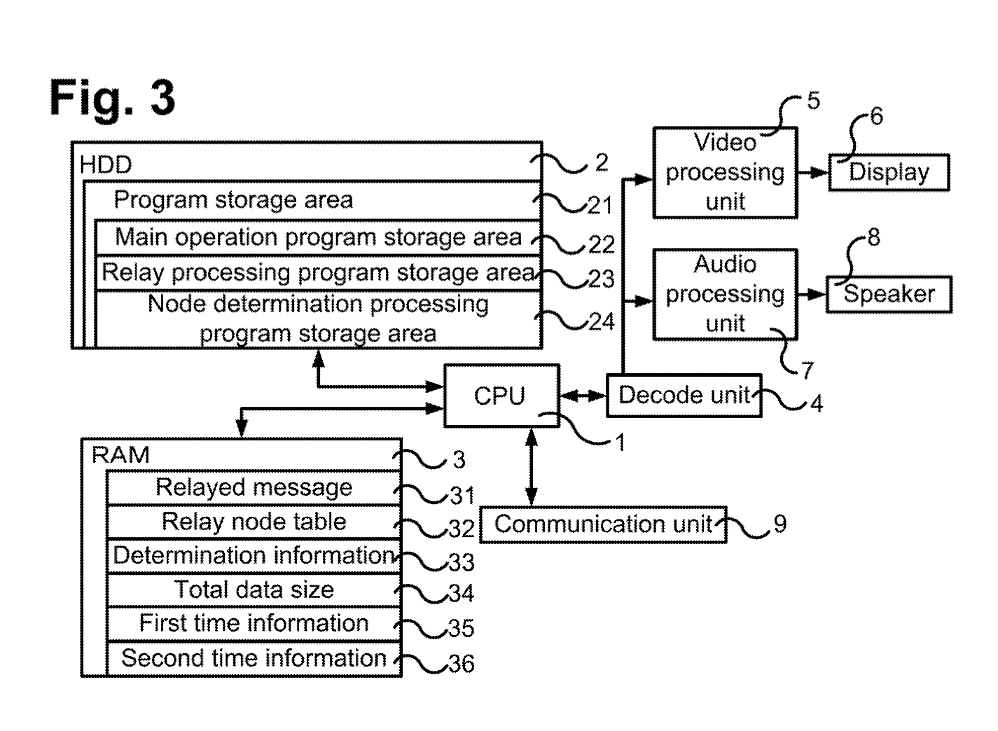

Subsequently, an electrical configuration of the node device will be described with reference to FIG. 3. As illustrated in FIG. 3, the node device of the present embodiment includes a CPU (Central Processing Unit) 1 for controlling the node device. The CPU 1 is electrically connected to an HDD (Hard Disk Drive) 2, a RAM (Random Access Memory) 3, a decoder unit 4, and a communication unit 9. Storage means, such as the HDD 2 and the RAM 3, and the CPU 1 form a computer of the node device. The CPU 1, the HDD 2, the RAM 3, the decoder unit 4, and the communication unit 9 are interconnected via a bus. A personal computer, an STB (Set Top Box), or the like is applicable as the node device.

The HDD 2 includes a program storage area 21. The program storage area 21 includes a main operation program storage area 22, a relay processing program storage area 23, and a node determination processing program storage area 24. The main operation program storage area 22 stores a main operation program. The main operation program causes the node device to perform a main operation. The relay processing program storage area 23 stores a relay processing program. The relay processing program is a program for causing the node device to perform a relay processing operation. The node determination processing program storage area 24 stores a node determination processing program. The node determination processing program causes the node device to determine whether the node device is the connectable node or the non-connectable node. The main operation program, the relay processing program, and the node determination processing program described above may be downloaded from, for example, a predetermined sever in the network NW, or may be recorded in a recording medium, such as a CD-ROM (Compact Disc-Read Only Memory), for example, and read via a drive for the recording medium.

The RAM 3 includes a relayed message temporary storage area 31, a relay node table temporary storage area 32, a determination information temporary storage area 33, a total data size temporary storage area 34, a first time information temporary storage area 35, and a second time information temporary storage area 36.

The relayed message temporary storage area 31 temporarily stores the relayed message received by the node device. The relayed message of the present embodiment includes both the control message relayed by the relay node device and the relayed content data. In the present embodiment, the information relayed by the relay node device will be referred to as the relayed message. Thus, the relayed message includes both the control message relayed by the relay node device and the relayed content data. The relay node table temporary storage area 32 temporarily stores the relay node table of the present embodiment. The determination information temporary storage area 33 temporarily stores the identification information indicating the connectable node or the identification information indicating the non-connectable node. The total data size temporary storage area 34 temporarily stores the above-described total data size. The first time information temporary storage area 35 temporarily stores first time information. The first time information is the information representing the time of start of the addition to the total data size. The second time information temporary storage area 36 temporarily stores second time information. The second time information is the information representing the time of request to the contact node to determine whether the node device is the connectable node or the non-connectable node.

The communication unit 9 controls the communication of information with a node device or an external device through the network NW. The communication unit 9 of the present embodiment is an example of a reception unit of the present invention.

The node device performs a reception process of receiving content data transmitted via the communication unit 9 in accordance with a request. The content data of the present embodiment is transmitted in packetized form. Each packet is received through the communication unit 9 and temporarily stored in the RAM 3. The thus temporarily stored content data is read from the RAM 3 and reproduced and output through the decoder unit 4, a video processing unit 5, an audio processing unit 7, a display 6, and a speaker 8. Alternatively, the content data stored in the RAM 3 may be read from the RAM 3 and stored in the HDD 2. Still alternatively, the content data may be directly stored in the HDD 2 without routing through the RAM 3. Thereafter, the content data is read from the HDD 2 in accordance with an operation instruction received from a user. The read content data is reproduced and output through the decoder unit 4, the video processing unit 5, the audio processing unit 7, the display 6, and the speaker 8. Thereby, the user can listen to and/or view the content.

### [Operation of Node Device of Present Embodiment]

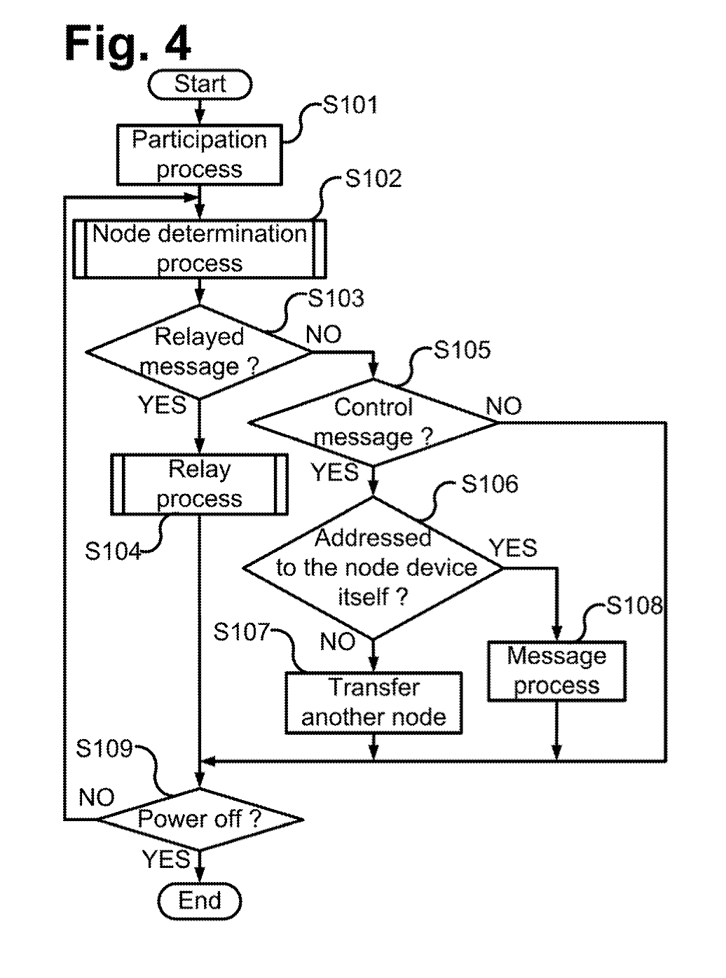

With reference to the accompanying drawings, description will be made of an operation and effects of the node device of the present embodiment comprising the above-described configuration. An operation and effects of the node device will be first described with reference to the accompanying drawings. The main operation illustrated in FIG. 4 is carried out when the node device is connected to a power supply or an external power supply, such as a commercial power supply, via an outlet and an installed P2P software program is executed by the CPU 1. The processes described below are performed by the CPU 1.

At Step S101, a participation process is performed.

In the participation process, the participation message is transmitted to a contact node of the information communication system S. With the participation message transmitted to the contact node, the DHT routing table is received. The received DHT routing table is stored in a predetermined storage area of the HDD 2. Further, as well as the participation process, a timer provided to the CPU 1 starts a time keeping operation. The timer is not illustrated in the drawings. The time of start of the time keeping operation is temporarily stored in the first time information temporary storage area 35. The information representing the present time may be acquired from the network NW via the communication unit 9. The CPU 1 performs the time keeping operation on the basis of the acquired time.

At Step S102, a node determination process is performed. In the node determination process at Step S102, a determination is made on whether the node device performing the main operation is the connectable node or the non-connectable node.

At Step S103, whether or not the relayed message has been received is determined. If the received message includes the identification information indicating the non-connectable node information, and if the node device received the message is the connectable node device, it is determined that the relayed message has been received. Specifically, by reference to the determination information temporarily stored in the determination information temporary storage area 33, a determination is made on whether the node device received the message is the connectable node or the non-connectable node. If it is determined that the relayed message has been received (YES at Step S103), Step S104 is performed. If it is not determined that the relayed message has been received (NO at Step S103), Step S105 is performed. If it is determined that the relayed message has been received, the received relayed message is temporarily stored in the relayed message temporary storage area 31. The computer and Step S103 of the present embodiment are an example of the reception unit of the present invention. Further, Step S103 of the present embodiment is an example of a reception step of the present invention.

At Step S104, a relay process is performed. At Step S104, the relayed message received at Step S103 is transferred to a non-connectable node. The computer and Step S104 of the present embodiment are an example of a relay unit of the present invention. Further, Step S104 of the present embodiment is an example of a relay step of the present invention.

At Step S105, whether or not the control message has been received is determined. If it is determined that the control message of the present embodiment has been received (YES at Step S105), Step S106 is performed. If it is not determined that the control message of the present embodiment has been received (NO at Step S105), Step S109 is performed.

At Step S106, a determination is made on whether or not the control message determined at Step S105 as received is the message addressed to the node device received the message. Whether or not the control message is the message addressed to the node device received the message is determined on the basis of the address of the received message. If the IP address in the address of the received message matches the IP address of the node device received the message, it is determined that the address of the control message is the node device. If it is determined that the address of the control message is the node device (YES at Step S106), Step S108 is performed. If it is not determined that the address of the control message is the node device (NO at Step S106), Step S107 is performed.

At Step S107, the control message received at Step S105 is transferred to another node device. Specifically, on the basis of the node information included in the control message received at Step S105 and the DHT routing table stored in the node device, the node device as the transfer destination of the control message is determined. The control message is transferred to the node device determined as the transfer destination.

At Step S108, the process corresponding to the control message received at Step S105 is performed. The process corresponding to one of the above-described control messages of the present embodiment is performed.

At Step S109, whether or not a power switch has been turned off by the user is determined. If the power switch has not been turned off, Step S102 is performed again. If the power switch has been turned off, the main operation process is completed.

### [Relay Process]

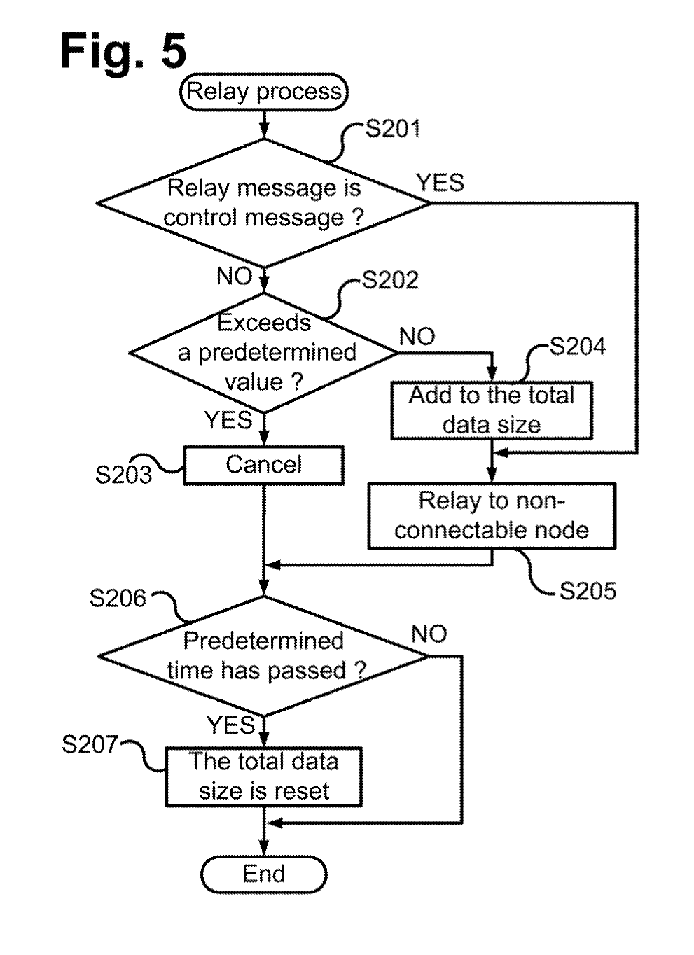

Subsequently, a process procedure of the relay processing operation of the present embodiment will be described with reference to FIG. 5. At Step S201, a determination is made on whether or not the received relayed message is the control message. Specifically, on the basis of the data size of the received relayed message, whether or not the relayed message is the control message is determined. If the data size of the relayed message corresponds to the data size of the control message (YES at Step S201), Step S204 is performed. If the data size of the relayed message does not correspond to the data size of the control message, i.e., if the content data is relayed (NO at Step S201), Step S202 is performed. The computer and Step S201 of the present embodiment are an example of a second determination unit of the present invention.

At Step S202, a determination is made on whether or not the total data size of the message relayed by the node device exceeds a predetermined value. Specifically, the total data size stored in the total data size temporary storage area 34 is referred to. On the basis of the referred total data size, a determination is made on whether or not the total data size of the relayed message exceeds the predetermined value. If it is determined that the total data size exceeds the predetermined value (YES at Step S202), Step S203 is performed. If it is not determined that the total data size exceeds the predetermined value (NO at Step S202), Step S204 is performed. The computer and Step S202 of the present embodiment are an example of a first determination unit of the present invention.

At Step S203, the relayed message received at Step S103 is cancelled. Specifically, the content data relayed by the relay node device is cancelled at Step S203. With the total data size exceeding the predetermined value, it is determined at Step S203 that it is difficult to relay data larger in data size than the currently relayed data. Therefore, the content data newly received as the relayed message at Step S103 is cancelled.

At Step S204, the data size of the relayed message received at Step S103 is added to the total data size. Specifically, the data size of the relayed message received at Step S103 is added to the total data size stored in the total data size temporary storage area 34. The total data size subjected to the addition is again temporarily stored in the total data size temporary storage area 34.

At Step S205, the relayed message received at Step S103 is relayed to the non-connectable node. Specifically, the control message or the content data is relayed to the non-connectable node as the relayed message. The computer and Steps S201, S202, S203, and S205 of the present embodiment are an example of a control unit of the present invention. Further, Step S205 of the present embodiment is an example of a control step of the present invention.

At Step S206, a determination is made on whether or not a predetermined time has passed since the time temporarily stored in the first time information temporary storage area 35. The predetermined time is, for example, ten seconds. If it is determined that the predetermined time has passed since the time temporarily stored in the first time information temporary storage area 35 (YES at Step S206), Step S207 is performed. If it is not determined that the predetermined time has passed since the time temporarily stored in the first time information temporary storage area 35 (NO at Step S206), the relay process is completed.

At Step S207, the value of the total data size stored in the total data size temporary storage area 34 is reset. Resetting refers to initializing the total data size temporary storage area 34 and temporarily storing therein the value Further, the time of execution of Step S207 is temporarily stored in the first time information temporary storage area 35.

### [Node Determination Process]

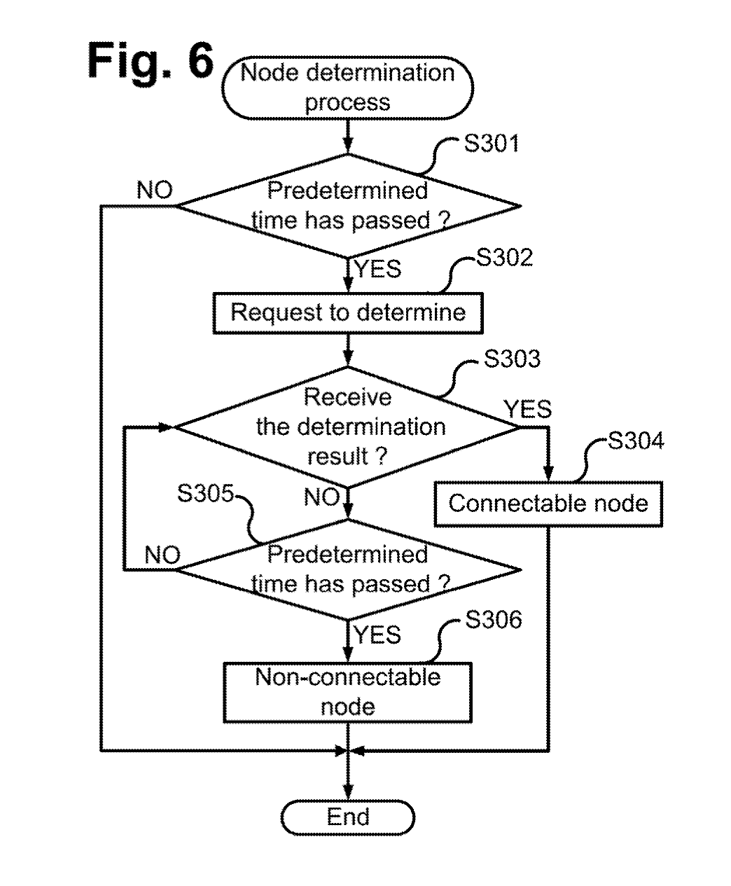

Subsequently, a process procedure of the node determination processing operation of the present embodiment will be described with reference to FIG. 6. At Step S301, a determination is made on whether or not a predetermined time has passed since the last node determination process. Specifically, the determination is made on the basis of the second time information temporarily stored in the second time information temporary storage area 36. A determination is made on whether or not the predetermined time is reached or exceeded by the difference between the present time measured by the timer and the time represented by the second time information temporarily stored in the second time information temporary storage area 36. If the second time information is not stored in the second time information temporary storage area 36, it is determined that the predetermined time or longer has passed. If it is determined that the predetermined time has passed since the last node determination process (YES at Step S301), Step S302 is performed. If it is not determined that the predetermined time has passed since the last node determination process (NO at Step S301), the node determination process is completed.

At Step S302, the contact node is requested to determine whether the node device is the connectable node or the non-connectable node. Specifically, a determination request message is transmitted from the node device to the contact node. Further, the time of request for the determination is temporarily stored in the second time information temporary storage area 36 as the second time information.

At Step S303, a determination is made on whether or not the determination result transmitted from the contact node has been received. Specifically, a determination is made on whether or not a message representing the determination result has been received from the contact node. If it is determined that the determination result has been received from the contact node (YES at Step S303), Step S304 is performed. If it is not determined that the determination result has been received from the contact node (NO at Step S303), Step S305 is performed.

At Step S304, the identification information indicating the connectable node information is temporarily stored in the determination information temporary storage area 33.

At Step S305, a determination is made on whether or not a predetermined time has passed since the request for the determination made at Step S302. Specifically, a determination is made on whether or not the predetermined time has passed since the time temporarily stored in the second time information temporary storage area 36. If it is determined that the predetermined time has passed (YES at Step S305), Step S306 is performed. If it is not determined that the predetermined time has passed (NO at Step S305), Step S303 is performed again.

At Step S306, the identification information indicating the non-connectable node information is temporarily stored in the determination information temporary storage area 33. In this process, the node device is determined as the non-connectable node due to the failure of the contact node to access the node device.

According to the relay node device of the present embodiment, when the data size of the data relayed by the relay node device exceeds a predetermined value, the relay of the content data is cancelled. Further, the relay of the control message continues, even if the data size of the data relayed by the relay node device exceeds the predetermined value. Consequently, it is possible to prevent a reduction in operational efficiency of the peer-to-peer communication system, without causing the standby or cancellation of the control message by the relay node device.

In the present embodiment, the relay of the content data is cancelled when the data size of the data relayed by the relay node device exceeds a predetermined value. Instead of the cancellation of the relay of the content data, the content data may be temporarily stored in the HDD 2 or the RAM 3 of the relay node device. In this case, the relay of the temporarily stored content data is resumed when the total data size falls to or below a predetermined value.

Further, the control message may be relayed in preference to the content data when the data size of the data relayed by the relay node device exceeds a predetermined value. In the following, an example of the method of preferentially relaying the control message will be described. A queue is generated in the HDD 2 or the RAM 3 as a storage device of the relay node device. Content data items required to be relayed are inserted into the queue in the order of reception by the relay node device. Then, the content data items are relayed in the order of insertion into the queue. Meanwhile, the control message required to be relayed is inserted into the head of the queue. As a result, the control message is relayed in preference to the content data. In other words, the relay of the content data is delayed.

The present embodiment is an example of the application of the present invention to the relay node device. The present invention may also be applied to a common node device. Specifically, when a node device transfers content data to another node device, the total data size of the data transferred by the node device is determined. If the determined total data size exceeds a predetermined value, the content data is cancelled or the transfer thereof is temporarily stopped, and the control message is preferentially transferred to the another node device. Further, when the node device downloads or uploads content data, the total data size of the data downloaded or uploaded by the node device is determined. If the determined total data size exceeds a predetermined value, the downloading or uploading of the content data is cancelled or temporarily stopped, and the control message is preferentially transferred to the another node device.

In the present embodiment, a method of canceling the content data to be relayed is used as the method of preferentially transmitting the control message to be relayed. As a modified example, the control message may be relayed as usual, and the content data may be limited in data size thereof transmitted per unit time. In other words, the relay of the content data may be delayed. For example, if the data size of the data which can be relayed per unit time by the relay node device is 5 MB (Mega Bytes) per second, the transmission of up to 0.5 MB of content data per 0.1 second may be allowed. With this configuration, the remaining data size available for the relay can be allocated to the relay of the control message. With this limitation of the amount of content data allowed to be relayed, it is possible to preferentially relay the control message, and to equally relay the content data without causing a local increase in the relay of the content data.

At Step S201 of the present embodiment, on the basis of the data size of the relayed message to be relayed, a determination is made on whether the message to be relayed is the control message or the content data. As a modified example of Step S201, the relayed message may be added with identification information for identifying the control message or the content data. If the relayed message added with the identification information is transmitted and received among the node devices, each of the node devices can determine whether the relayed message is the control message or the content data. The computer of the present embodiment and Step S201 of the modified example are an example of a third determination unit of the present invention.

In the present embodiment, whether or not the total data size exceeds a predetermined value is determined at Step S202. The predetermined value is set to be lower than the upstream band or the downstream band of the node device. A bandwidth corresponding to a few percent of the upstream band or the downstream band of the node device may be set as the predetermined value. Further, in the above-described embodiment, the peer-to-peer network using the DHT is applied to the overlay network. However, the overlay network is not limited thereto. For example, another peer-to-peer system or a system using an overlay network may also be applied. The peer-to-peer system not using the DHT includes, for example, a hybrid peer-to-peer system.

Although an illustrative embodiment and examples of modifications of the present invention have been described in detail herein, the scope of the invention is not limited thereto. It will be appreciated by those skilled in the art that various modifications may be made without departing from the scope of the invention. Accordingly, the embodiment and examples of modifications disclosed herein are merely illustrative. It is to be understood that the scope of the invention is not to be so limited thereby, but is to be determined by the claims which follow.

What is claimed is:

1. An information communication system using an overlay network formed by a plurality of node devices connected via a network, at least one of the plurality of node devices comprising:
a reception unit configured to receive a control message for controlling the information communication system or content data transmitted and received among the plurality of node devices in the information communication system;
a relay unit configured to relay the control message or the content data received by the reception unit to another one of the node devices; and
a control unit configured to control the relay unit to relay the control message in preference to the content data.

2. The information communication system according to claim 1, wherein the plurality of node devices include a first node device incapable of receiving information from the network, and a relay node device relaying information transmitted from the network to the first node device,
wherein the relay node device includes the reception unit and the relay unit, and
wherein the relay unit relays the control message or the content data received by the reception unit to the first node device.

3. The information communication system according to claim 2 wherein the node device or the relay node device further comprises:
a first determination unit configured to determine whether the total data size of the control message or the content data relayed by the relay unit has exceeded a predetermined data size, and
wherein, in response to determining that the total data size has exceeded the predetermined data size by the first determination unit, the control unit controls the relay unit to relay the control message in preference to the content data.

4. The information communication system according to claim 3, wherein, in response :o determining that the total data size has exceeded the predetermined data size by the first determination unit, the control unit controls the relay unit to stop the relay of the content data.

5. The information communication system according to claim 3, wherein, in response to determining that the total data size has exceeded the predetermined data size by the first determination unit, the control unit controls the relay unit to delay the relay of the content data.

6. The information communication system according to claim 3 wherein the node device or the relay node device further comprises: a second determination unit configured to determine, on the basis of the data size of the information received by the reception unit, whether the received information is the control message or the content data,
wherein, in response to determining that the content data has been received by the second determination unit, the first determination unit determines whether the total data size has exceeded the predetermined data size, and
wherein, in response to determining that the total data size has exceeded the predetermined data size by the first determination unit, the control unit controls the relay unit to stop the relay of the content data.

7. The information communication system according to claim 6, wherein when the minimum data size of the content data is larger than the data size of the control message, the second determination unit determines, on the basis of the data size of the information received by the reception unit, whether the received information is the control message or the content data.

8. The information communication system according to claim 6, wherein the content data is divided into one or more divided content data pieces each comprising a predetermined data size,
wherein the data size of the divided content data piece is larger than the data size of the control message, and
wherein the second determination unit determines, on the basis of the data size of The information received by the reception unit, whether the received information is the control message or the content data.

9. The information communication system according to claim 3, wherein the reception unit receives the content data or the control message and identification information for identifying the content data or the control message,
wherein the reception unit includes a third determination unit configured to determine, on the basis of the identification information received by the reception unit, whether the received information is the control message or the content data,
wherein, in response to determining that the content data has been received by the Third determination unit, the first determination unit determines whether the total data size has exceeded the predetermined data size, and
wherein, in response to determining that the total data size has exceeded the predetermined data size by the first determination unit, the control unit controls the relay unit to stop the relay of the content data.

10. A node device of an information communication system using an overlay network formed by a plurality of the node devices connected via a network, the node device comprises:
a reception unit configured to receive a control message for controlling the information communication system or content data transmitted and received among the plurality of node devices in the information communication system;
a relay unit configured to relay the control message or the content data received by the reception unit to another one of the node devices; and
a control unit configured to control the relay unit to relay the control message in preference to the content data.

11. A non-transitory computer readable storage medium recording a program for operating a computer of a node device of an information communication system using an overlay network formed by a plurality of the node devices connected via a network, the program causing the computer of the node device to execute:
receiving a control message for controlling the information communication system or content data transmitted and received among the plurality of node devices in the information communication system;
relaying the control message or the content data received by the reception step to another one of the node devices; and
controlling the relay step to relay the control message in preference to the content data.

12. An information communication method using an overlay network formed by a plurality of node devices connected via a network, the method comprises:
receiving a control message for controlling the information communication system or content data transmitted and received among the plurality of node devices in the information communication system;
relaying the control message or the content data received by the reception step to another one of the node devices; and
a controlling the relay step to relay the control message in preference to the content data.
